(19) United States
(12) Patent Application Publication
(10) Pub. No.: US 2015/0327564 A1
(43) Pub. Date: Nov. 19, 2015

(54) CHEESE SAUCE COMPRISING VEGETABLES

(71) Applicant: WhiteWave Services, Inc., Denver, CO (US)

(72) Inventor: Adam Martin Stoklosa, Denver, CO (US)

(73) Assignee: WhiteWave Services, Inc., Denver, CO (US)

(21) Appl. No.: 14/277,488

(22) Filed: May 14, 2014

(51) Int. Cl. A23C 19/09

(52) U.S. Cl. CPC A23C 19/0904

(57) ABSTRACT

According to one embodiment, a cheese sauce comprises 13% to 17% carrot powder, 5% to 7% parsnip powder, 18% to 22% maltodextrin, 12% to 16% cheddar cheese, 12% to 16% whey, 10% to 14% salt, 6% to 8% corn starch, 3% to 5% nonfat dry milk, 2% to 4% butter, and 0.01% to 2% natural flavor, 0.01% to 2% disodium phosphate, 0.01% to 2% lactic acid, and 0.01% to 2% citric acid.

### TECHNICAL FIELD OF THE DISCLOSURE

This invention relates in general to a cheese sauce and more particularly to a cheese sauce comprising vegetables.

### BACKGROUND

Parents want their children to consume more vegetables, but the sensory characteristics of vegetables are less than desirable for some children. To address the desires of both parent and child, food products that appeal to children may be used as a vehicle for vegetable delivery. For example, macaroni and cheese products may incorporate vegetables into the pasta as a vehicle for vegetable delivery. Unfortunately, the flavor, aroma, texture, and appearance of pasta containing a nutritionally beneficial amount of vegetables may tend to differ significantly from traditional pasta and could result in poor acceptance by children.

### SUMMARY

According to one embodiment, a cheese sauce comprises 13% to 17% carrot powder, 5% to 7% parsnip powder, 18% to 22% maltodextrin, 12% to 16% cheddar cheese, 12% to 16% whey, 10% to 14% salt, 6% to 8% corn starch, 3% to 5% nonfat dry milk, 2% to 4% butter, and 0.01% to 2% natural flavor, 0.01% to 2% disodium phosphate, 0.01% to 2% lactic acid, and 0.01% to 2% citric acid.

Certain embodiments of the present disclosure can provide one or more technical advantages. As an example, in some embodiments, a dried cheese sauce powder is used as a vehicle to deliver a ½ serving of dried vegetable powders. Dried vegetables deliver the nutrients of fresh produce, but in a concentrated, shelf stable form. Thus, a ½ serving of vegetables can be delivered with only a few grams of concentrate. In some embodiments, vegetables with milder flavor profiles may be selected so that a vegetable enriched cheese sauce tastes like a traditional cheese sauce, such as a cheddar sauce used in macaroni and cheese products. In addition, the selection of vegetables may function to color the final product a traditional cheese color that may result in favorable acceptance by consumers. In some embodiments, the dried vegetable powders may be combined with certain ingredients used in traditional cheese sauce and may be packaged using conventional packaging equipment. Consumer preparation may be identical to classic preparation. For example, the consumer may prepare macaroni and cheese by mixing the powdered cheese sauce with cooked pasta and optionally water, butter, milk, or other classic macaroni and cheese ingredients.

Other technical advantages of the present disclosure will be readily apparent to one skilled in the art from the following figures, descriptions, and claims. Moreover, while specific advantages have been enumerated above, various embodiments can include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example of a system for making a yellow cheddar cheese sauce comprising vegetables; and

FIG. 2 illustrates an example of a method for making a yellow cheddar cheese sauce comprising vegetables.

### DETAILED DESCRIPTION

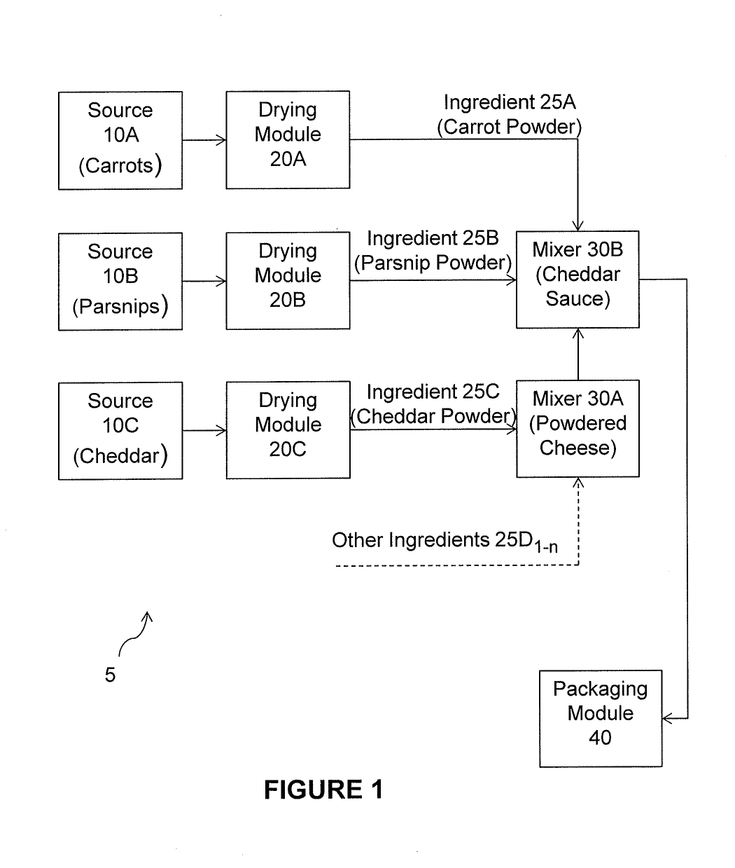

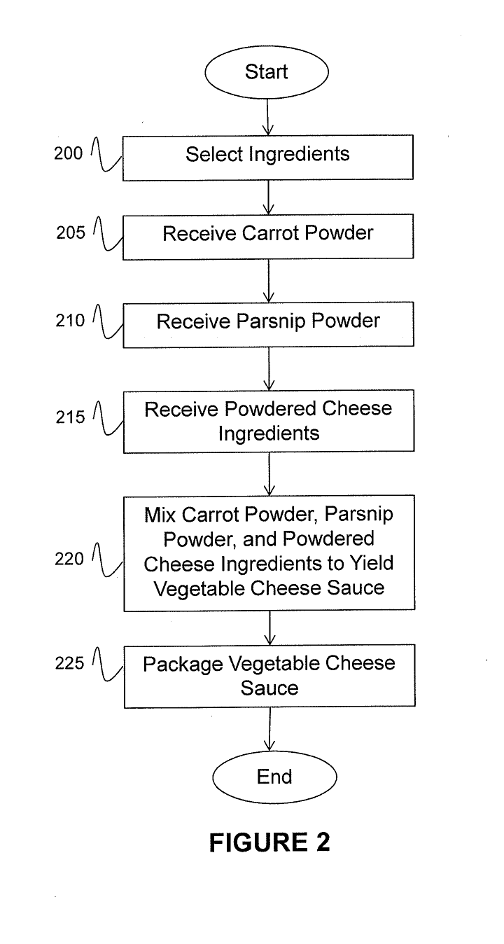

Embodiments of the present invention and its advantages are best understood by referring to FIGS. 1 to 2 of the drawings, like numerals being used for like and corresponding parts of the various drawings.

FIG. 1 illustrates an example of a system 5 for making a yellow cheddar cheese sauce comprising vegetables. System 5 includes one or more sources 10, drying modules 20, ingredient dispensers 25, mixers 30, and packaging module 40.

In operation, an operator of system 5 selects appropriate ingredients for the desired finished product. In some embodiments, the operator may select carrots, parsnips, and cheddar cheese as base ingredients for a cheese sauce comprising a ½ serving of vegetables. Ingredients may be introduced into system 5 through any suitable source 10. In some embodiments source 10A provides carrots in raw form, source 10B in raw form, and source 10C provides cheddar cheese (e.g., a combination of cultured pasteurized milk, salt, and enzymes prepared according to conventional processes).

From sources 10, the ingredients may be introduced into a drying module 20. Drying module 20A receives carrots from source 20A, processes the carrots to form a carrot slurry, and dries the carrot slurry to yield a carrot powder. Similarly, drying module 20B receives parsnips from source 20B, processes the parsnips to form a parsnip slurry, and dries the parsnip slurry to yield a parsnip powder. In some embodiments, drying modules 20A and 20B comprise infrared driers. In some embodiments, the carrot powder and the parsnip powder formed by drying modules 20A and 20B may be free of added ingredients (such as bulking agents). Due to the high water content in the carrots and parsnips, the drying process may cause the nutritional components of the vegetables to become concentrated such that a relatively small amount of vegetable powder provides a half serving of vegetables to the cheese sauce. For example, a 28 gram package of cheese sauce may include approximately 9 grams of vegetable powder (e.g., a combination of carrot powder and parsnip powder) to provide the nutrition of ½ serving of vegetables per serving of macaroni and cheese. Drying module 20C receives cheddar cheese from source 20C and spray dries the cheddar cheese.

From drying modules 20, the ingredients are sent to ingredient dispensers 25. In some embodiments, drying modules 20 may be associated with one or more off-site and/or third party equipment. The carrot powder, parsnip powder, and spray-dried cheddar may be packaged, transported to a mixing facility, and introduced into ingredient dispenser 25. Ingredient dispenser 25 may include any suitable outlet, hose, dosing component, etc. for dispensing a desired amount of an ingredient into to mixer 30.

In some embodiments, ingredient dispenser 25C dispenses cheddar powder into a first mixer 30A and ingredient dispensers 25D₁₋ₙ dispense other ingredients into first mixer 30A to form a powdered cheese. Examples of possible other ingredients include dry/powdered forms of maltodextrin, whey, salt, corn starch, nonfat dry milk, butter, natural flavor, disodium phosphate, lactic acid, and citric acid. Ingredients can be added serially (i.e., one at time), collectively (i.e., all ingredients are added substantially at once), or a combination (i.e., certain subsets of ingredients are pre-combined, and the combination is added serially with other ingredients or ingredient combinations). First mixer 30A may then blend the ingredients together until they are substantially evenly distributed.

The powdered cheese mixture is blended with the carrot powder and the parsnip powder. FIG. 1 illustrates an example where ingredient dispenser 25A dispenses carrot powder in a second mixer 30B, ingredient dispenser 25B dispenses parsnip powder in second mixer 30B, and the powdered cheese mixture is transported from first mixer 30A to second mixer 30B. Using two mixers 30 may allow one portion of the powdered cheese mixture to be sent to second mixer 30B to form a vegetable cheese sauce and another portion of the powdered cheese mixture to be sent to other equipment for use in other products (e.g., non-vegetable cheese sauces). The powdered cheese mixture may be transported from first mixer 30A to second mixer 30B in any suitable manner. For example, first mixer 30A may dispense the powdered cheese mixture directly to second mixer 30B. Or, first mixer 30A may dispense the powdered cheese to packaging equipment that packages the powdered cheese mixture for shipment to another facility that houses second mixer 30B for eventual incorporation in a cheese sauce. Although the preceding example describes the use of multiple mixers 30, in other embodiments, the same mixer 30 could be used to combine all of the ingredients (e.g., dispensers 25A, 25B, 25C, and 25D could dispense ingredients into the same mixer 30).

After an appropriate mixing time, the vegetable cheese sauce can be discharged into packaging module 40 manually or through one or more nozzles, hoses, spigots, or other appropriate discharging outlet. In some embodiments, packaging module 40 packages the vegetable cheese sauce into a packet and packages the packet within a box of pasta. As an example, packaging module 40 may package 28 g of vegetable cheese sauce in a packet and box the packet with 140 g of pasta.

Modifications, additions, or omissions can be made to system 5 without departing from the scope of the invention. The components of system 5 can be integrated or separated. Moreover, the operations of system 5 can be performed by more, fewer, or other components.

FIG. 2 is a flow diagram illustrating a method of making a yellow cheddar cheese sauce with vegetables. The method begins at step 200 be selecting ingredients for the vegetable cheese sauce. Examples of ingredients include carrot powder, parsnip powder, and powdered cheese ingredients. In some embodiments, the powdered cheese ingredients may include spray-dried cheese and one or more optional other ingredients. Examples of optional other ingredients include, but are not limited to, sweeteners, stabilizers, health supplements, flavors, extracts, coloring agents, salts, functional ingredients, water, and/or other suitable ingredients.

Sweeteners can be added to enhance the taste of the flavorings provided and/or provide overall sweetness to the product. In particular embodiments, sweeteners can include natural sweeteners, artificial sweeteners, or a combination. Examples of natural sweeteners include sugar (e.g., liquid sugar, crystallized sugar, honey, agave, cane juice, etc.) and stevia and its derivatives (e.g., steviol glycosides, rebiana-A, and rebaudioside-A). Examples of artificial sweeteners include sucralose, aspartame, and saccharine. However, in some embodiments, the carrot powder and parsnip powder may provide sweetness such that the need for added sweeteners may be reduced or eliminated.

Stabilizers can enhance physical properties of beverages by imparting viscosity or mouthfeel properties that can increase consumer appeal. Stabilizers can be natural or artificial and can contribute to a uniform appearance of products by stabilizing and or suspending insoluble materials and preventing separation or settling of ingredients. Examples of stabilizers can include, but are not limited to, emulsifiers, starches, and various gums and/or hydrocolloids such as guar, acacia, locust bean, xanthan, gellan, carrageenan, cellulose, and pectin.

Health supplements can enhance the nutritional profile of the food product or provide health benefits. Examples of health supplements include vitamins (e.g., vitamin A, B vitamins, vitamin C, vitamin D, vitamin E, etc.), minerals (e.g., calcium, potassium), herbs (e.g., chamomile, lavender, lemon balm), and probiotics (e.g., yogurt cultures).

Flavors and coloring agents can be added to enhance and/or change the physical properties of the mixture, such as the taste and the visual appearance respectively. In some embodiments, natural flavors may be selected to add acidity to the vegetable cheese sauce in order to mask the sweetness of the carrot powder.

Salts can be added to improve taste and/or to act as buffering agents to enhance protein stability. Examples of salts include sodium citrate, sodium chloride, potassium citrate, potassium phosphate, and dipotassium phosphate.

Functional ingredients can enhance the functionality of food products and can include plant sterols, bulking agents, such as fiber, or other functional ingredients.

The following TABLES 1 and 2 illustrates example ingredients that can be selected for a vegetable cheese sauce. Although certain amounts are described, by weight, ingredients can be increased or decreased to yield the desired properties. In some embodiments, dry ingredients can be pre-blended in a ratio selected to yield a suitable amount of each dry ingredient when the pre-blend is added to the mixture.

TABLE 1
VEGETABLE CHEESE SAUCE

| Ingredient | Example Range |
|---|---|
| Carrot Powder | 13% to 17% |
| Parsnip Powder | 5% to 7% |
| Powdered Cheese | Balance |
| Ingredients | |

TABLE 2
POWDERED CHEESE INGREDIENTS

| Ingredient | Example Range |
|---|---|
| Maltodextrin | 18% to 22% |
| Cheddar Cheese | 12% to 16% |
| Whey | 12% to 16% |
| Salt | 10% to 14% |
| Cornstarch | 6% to 8% |
| Nonfat Dry Milk | 3% to 5% |
| Butter | 2% to 4% |
| Natural Flavor | 0.01% to 2% |
| Disodium Phosphate | 0.01% to 2% |
| Lactic Acid | 0.01% to 2% |
| Citric Acid | 0.01% to 2% |

In TABLE 2, the example ranges are given as percentages of the overall vegetable cheese sauce formula. Thus, the percentages may be different if measured with reference to only the powdered cheese ingredients. Other embodiments may omit one or more ingredients from the powdered cheese ingredients, other ingredients could be added, and the amounts of the various ingredients could be modified.

At step 205, the carrot powder is received in a mixer; at step 201, the parsnip powder is received in the mixer; and at step 215, the powdered cheese ingredients are received in the mixer. The powdered cheese ingredients may be dispensed in the mixer as a pre-blend, or some of the ingredients or subsets of the ingredients could be introduced separately. The carrot powder, parsnip powder, and powdered cheese ingredients are mixed at step 220. When the ingredients are dispersed substantially evenly throughout, the vegetable cheese sauce mixture exits the mixer and is directed to the packaging module. The packaging module packages the vegetable cheese sauce and optionally boxes the cheese sauce package with pasta. The packaging may include consumer preparation instructions consistent with classic macaroni and cheese. For example, the consumer may prepare macaroni and cheese by mixing the powdered cheese sauce with cooked pasta and optionally water, butter, milk, or other classic macaroni and cheese ingredients.

The steps illustrated in FIG. 2 can be combined, modified, or deleted where appropriate, and additional steps can also be added to those shown. Additionally, the steps can be performed in any suitable order without departing from the scope of the present disclosure. For example, some or all of the ingredients can be added collectively at a similar time or alternatively ingredients can be added serially at different times.

The systems and methods described can include one or more technical advantages. As an example, a cheese sauce may be used as a delivery method for a half serving of vegetables. Typically, adding vegetables in sufficient quantities to deliver a half serving of vegetables creates an off flavor, an off appearance, or both. For example, adding a half serving of carrots creates a bland, somewhat sweet flavor profile and provides too much orange color. Adding a half serving of sweet potatoes creates an overly sweet flavor profile. Adding a half serving of pumpkin creates an overly bitter profile. Adding turnips, broccoli, or cauliflower may create odor, flavor, and/or color problems. However, combining powdered cheese ingredients in a cheese sauce comprising 13-17% carrot powder and 5-7% parsnip powder advantageously yielded the unexpected result that a half serving of vegetables could be delivered in a cheese sauce while maintaining a color, consistency, flavor, and sweet-to-savory profile similar to a classic, non-vegetable cheese sauce. An advantage of some embodiments includes blending existing cheese ingredients with the carrot powder and parsnip powder ingredients to deliver the vegetable claims without requiring additional, unusual ingredients to offset the flavor or texture of the vegetables. Particular embodiments can provide some, none, or all of these operational benefits, and can provide additional operational benefits.

Although the present disclosure has been described with several embodiments, numerous changes, variations, alterations, transformations, and modifications can be suggested to one skilled in the art, and it is intended that the present disclosure encompass such changes, variations, alterations, transformations, and modifications as fall within the scope of the appended claims.

What is claimed is:

1. A cheese sauce, comprising:
carrot powder present in an amount between approximately 13% to 17% of the cheese sauce; and
parsnip powder present in an amount between approximately 5% to 7% of the cheese sauce;
wherein the remainder of the cheese sauce comprises powdered cheese ingredients, the powdered cheese ingredients comprising:
maltodextrin present in an amount between approximately 18% to 22% of the cheese sauce;
cheddar cheese present in an amount between approximately 12% to 16% of the cheese sauce;
whey present in an amount between approximately 12% to 16% of the cheese sauce;
salt present in an amount between approximately 10% to 14% of the cheese sauce;
corn starch present in an amount between approximately 6% to 8% of the cheese sauce;
nonfat dry milk present in an amount between approximately 3% to 5% of the cheese sauce;
butter present in an amount between approximately 2% to 4% of the cheese sauce;
natural flavor present in an amount between approximately 0.01% to 2% of the cheese sauce;
disodium phosphate present in an amount between approximately 0.01% to 2% of the cheese sauce;
lactic acid present in an amount between approximately 0.01% to 2% of the cheese sauce; and
citric acid present in an amount between approximately 0.01% to 2% of the cheese sauce.

2. A cheese sauce, comprising:
carrot powder comprising 13% to 17% of the cheese sauce;
parsnip powder comprising 5% to 7% of the cheese sauce; and
wherein the remainder of the cheese sauce comprises powdered cheese ingredients.

3. The cheese sauce of claim 2, wherein the powdered cheese ingredients comprise cheddar cheese in spray-dried form, the cheddar cheese consisting essentially of cultured pasteurized milk, salt, and enzymes.

4. The cheese sauce of claim 2, wherein the powdered cheese ingredients comprise spray-dried cheddar cheese present in an amount between approximately 12% to 16% of the cheese sauce.

5. The cheese sauce of claim 4, wherein the powdered cheese ingredients comprise nonfat dry milk present in an amount between approximately 3% to 5% of the cheese sauce.

6. The cheese sauce of claim 5, wherein the powdered cheese ingredients comprise butter present in an amount between approximately 2% to 4% of the cheese sauce, the butter consisting essentially of cream and salt.

7. The cheese sauce of claim 6, wherein the powdered cheese ingredients comprise maltodextrin present in an amount between approximately 18% to 22% of the cheese sauce.

8. The cheese sauce of claim 7, wherein the powdered cheese ingredients comprise salt present in an amount between approximately 10% to 14% of the cheese sauce.

9. The cheese sauce of claim 8, wherein the powdered cheese ingredients comprise whey present in an amount between approximately 12% to 16% of the cheese sauce.

10. The cheese sauce of claim 9, wherein the powdered cheese ingredients comprise corn starch present in an amount between approximately 6% to 8% of the cheese sauce.
